(19) United States
(12) Patent Application Publication
(10) Pub. No.: US 2014/0102746 A1
(43) Pub. Date: Apr. 17, 2014

(54) SEMI-PERMANENT MODULAR SURFACE MOUNTABLE ELECTRIC POWER DISTRIBUTION SYSTEM

(71) Applicants: Sandra B. WRIGHTSON, Oxford, MD (US); Francis H. WRIGHTSON, Oxford, MD (US)

(72) Inventors: Sandra B. WRIGHTSON, Oxford, MD (US); Francis H. WRIGHTSON, Oxford, MD (US)

(21) Appl. No.: 14/049,944

(22) Filed: Oct. 9, 2013

Related U.S. Application Data
(60) Provisional application No. 61/712,615, filed on Oct. 11, 2012.

(51) Int. Cl. H01R 3/00

(52) U.S. Cl. CPC H01R 3/00
USPC 174/53

(57) ABSTRACT

The present invention is directed to providing a modular surface mountable electric power distribution system, comprising a plurality of interconnectable power distribution devices. Each power distribution device in the plurality of power distribution devices includes a hollow rigid enclosure for containing at least electric power conductors and connectors; electric power conductors for transferring power received from an external power source; at least one male connector; and at least one female connector. At least one male connector of a first power distribution device is connectable to a female connector of a second power distribution device. A hollow rigid enclosure of a first power distribution device is connectable to the hollow rigid enclosure of a second power distribution device. The hollow rigid enclosure of each device is mountable on a substantially flat surface and at least one male connector is connectable to said external power source.

### CROSS REFERENCES TO RELATED APPLICATIONS

This application claims the benefit of U.S. Provisional Patent Application No. 61/712,615 filed on Oct. 11, 2012, in the name of Sandra B. Wrightson, entitled “SEMI-PERMANENT RIGID SURFACE MOUNTED EXTENSION CORD SYSTEM” the disclosure of which is expressly incorporated herein by reference in its entirety.

### BACKGROUND OF THE INVENTION

1. Field of the Invention

The present invention is related to improved apparatus for electric extension cords and the like. More particularly, but not by way of limitation, the present invention relates to a semi-permanent rigid surface mounted extension cord system composed of multiple sized electrical components to supply electricity for various appliances.

2. Background of the Invention and Related Art

Devices presently available consist of a dangerous array of flexible extension cords which do not stay where they are placed. They look ugly, unfinished and temporary. They create tripping hazards and multiple dangers for child safety. Rooms/porches/basements which are added or finished after a house is complete often do not have the capability of interior wiring and therefore require some type of surface mounted system. Present systems of surface mounted wiring require installation by a licensed electrician and consist of hardwired conduit and unsightly metal or plastic receptacles.

### SUMMARY OF THE INVENTION

The present invention is directed to providing a comprehensive set of devices designed to work together to create an extremely functional, versatile, safe system which can be incorporated into the existing décor without looking like an afterthought and can easily be installed by the user. The present invention provides a rigid surface mounted extension cord system composed of multiple sized electrical components to supply electricity for various appliances. It may directly plug in to an existing receptacle or operate by attached switch, remote control or sensor. The device is a multiple piece construction utilizing standard various voltage or current. It complies with manufacturing codes for residential appliance use and grounding requirements for residential or commercial wiring codes. The hollow rigid enclosures of the present invention provide flexibility to accommodate various wire gauges depending on anticipated use.

This system does not require a licensed electrician for installation. It is a “Do it Yourself” component power supply system similar to plugging in an extension cord. The length is adjustable to any room and the system permits variable placement of receptacles as needed to operate lighting and/or appliances. It is visually appealing by contrast to extension cord wires and eliminates safety hazard of tripping on cords. The pieces can be manufactured to standard molding design and in various colors with a paintable surface. It can be made to be weatherproof for deck or patio lighting and other electrical power supply/need.

In a first broad aspect, the present invention is directed to providing a modular surface mountable electric power distribution system, comprising a plurality of interconnectable power distribution devices. Each power distribution device in the plurality of power distribution devices includes a hollow rigid enclosure for containing at least electric power conductors and connectors; electric power conductors for transferring power received from an external power source; at least one male connector; and at least one female connector. At least one male connector of a first power distribution device is connectable to a female connector of a second power distribution device. A hollow rigid enclosure of a first power distribution device is connectable to the hollow rigid enclosure of a second power distribution device. The hollow rigid enclosure of each device is mountable on a substantially flat surface and at least one male connector is connectable to said external power source.

In the electric power distribution system of the present invention, the male connector and female connector may comprise a water resistant configuration. Further, the hollow rigid enclosures of the present invention may comprise a water resistant configuration when the hollow rigid enclosure of a first power distribution device is connected to the hollow rigid enclosure of a second power distribution device.

The electric power distribution system of the present invention may include a unique connector with at least one female receptacle mounted on a surface of the hollow rigid enclosure and one male plug and one female receptacle at each end of the hollow rigid enclosure to allow interconnection with a plurality of power distribution devices.

The electric power distribution system of the present invention may further comprise at least one adjustable length telescoping power distribution device, as well as a plurality of hollow rigid enclosures having differing dimensions and shapes. The hollow rigid enclosures may include electrical insulation and further comprise a decorative exterior appearance. The hollow rigid enclosure may be fabricated using one of wood, metal, plastic, and composites.

The electric power distribution system of the present invention may include at least one ground fault protector; at least one indicator light that illuminates when power is present; at least one switch that shuts off the power to at least one said power distribution device; at least one power monitoring device that allows the user to monitor the current being transferred; and at least one remote control that controls the supply of power.

The hollow rigid enclosures included in the electric power distribution system of the present invention may further comprise mounting penetrations for attachment to a surface using at least fasteners, or clip mounting brackets to attach each power distribution device to a surface.

In a second broad aspect, the present invention is directed to providing a power distribution device connectable in a modular surface mountable electric power distribution system, comprising a hollow rigid enclosure for containing at least electric power conductors and connectors; electric power conductors for transferring power received from an external power source; at least one male connector; and at least one female connector. The at least one male connector of a first power distribution device is connectable to a female connector of a second power distribution device. The hollow rigid enclosure of a first power distribution device is connectable to the hollow rigid enclosure of a second power distribution device. The hollow rigid enclosure is mountable on a substantially flat surface, and the at least one male connector is connectable to the external power source.

The power distribution device of the present invention may include a unique connector with at least one female receptacle mounted on a surface of the hollow rigid enclosure and one male plug and one female receptacle at each end of the hollow rigid enclosure to allow interconnection with a plurality of power distribution devices. The hollow rigid enclosure may have telescoping properties, a power indicator light, a ground fault protector, a power off switch, and a power monitoring device. In addition, data signal connectors and cables for distributed access to an external data port may be included.

### BRIEF DESCRIPTION OF THE DRAWINGS

FIG. 1 is a non-limiting drawing of a hollow rigid enclosure of the present invention.

FIG. 2 is a non-limiting drawing of internal wiring of a hollow rigid enclosure and a telescoping feature of the present invention.

FIG. 3 is a non-limiting drawing of a hollow rigid enclosure of the present invention configured as corner components, and a unique multi-connector receptacle.

FIG. 4 is a non-limiting drawing showing two configurations of the unique receptacle of the present invention.

### DETAILED DESCRIPTION OF PREFERRED EMBODIMENTS OF THE INVENTION

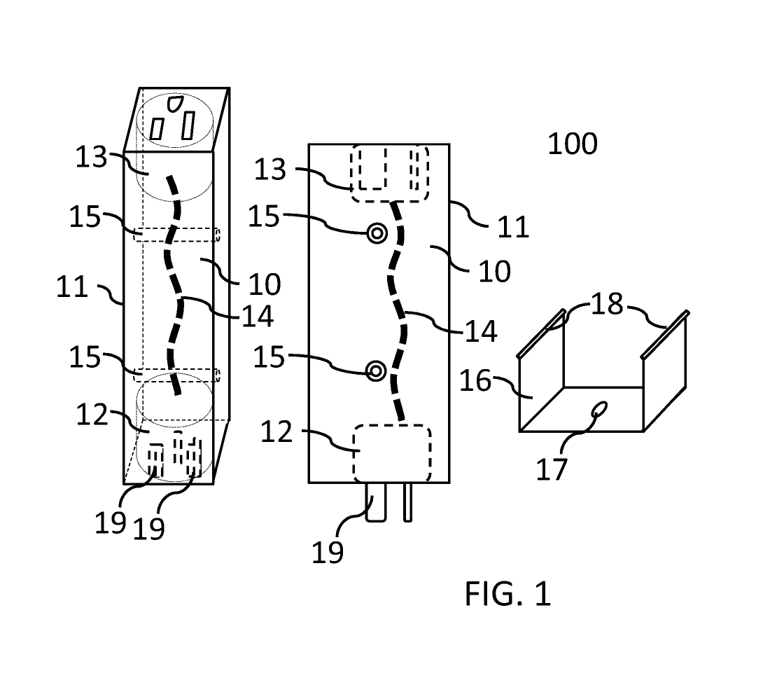

Referring now to FIG. 1, the present invention 100 is directed to providing a modular surface mountable electric power distribution system, comprising a plurality of interconnectable power distribution devices 11. Each power distribution device 11 in the plurality of rigid power distribution devices 11 includes a hollow rigid enclosure 10 for containing at least electric power conductors 14 and connectors 12 & 13; electric power conductors 19 for transferring power received from an external power source; at least one male connector 12; and at least one female connector 13. At least one male connector 12 of a first power distribution device 11 is connectable to a female connector 13 of at least a second power distribution device 11. A hollow rigid enclosure 10 of a first power distribution device 11 is connectable to the hollow rigid enclosure 10 of a second power distribution device 11. The hollow rigid enclosure 10 of each device 11 is mountable on a substantially flat surface using a fastener positioned through a protected tubular pathway 15, or by mounting a bracket 16 on said surface using a fastener penetrating a mounting hole 17 in said bracket. A least one male connector 12 is connectable to said external power source. In some embodiments, said male connector 12 may be extendable outside said hollow rigid enclosure 10, extending a portion of said electric power conductor 14 outside said hollow rigid structure 10.

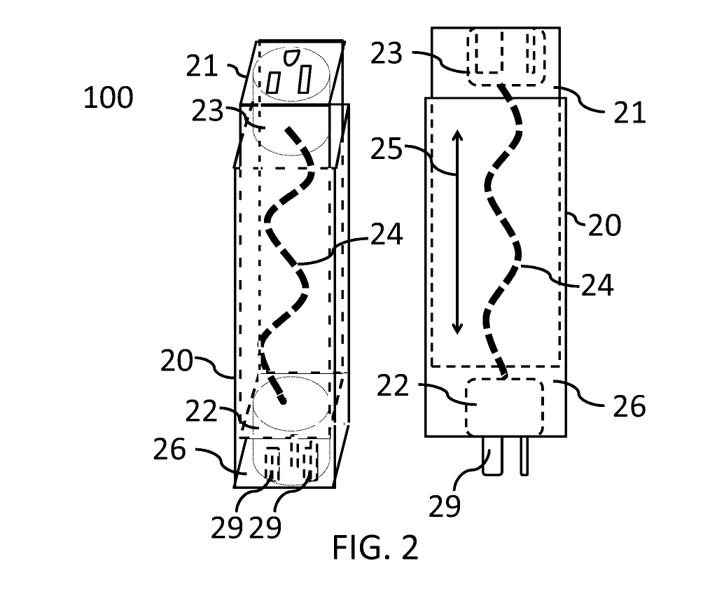

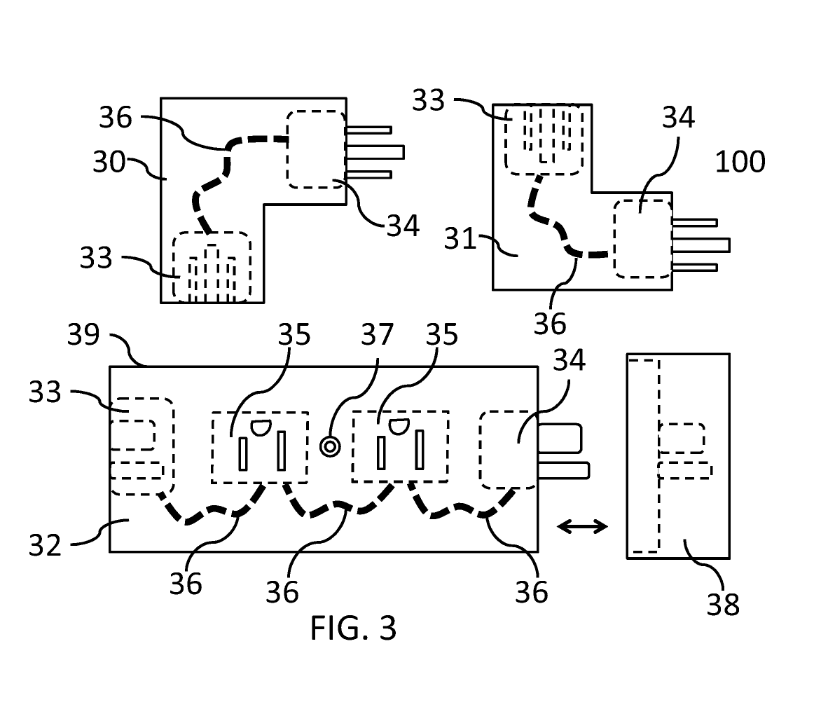

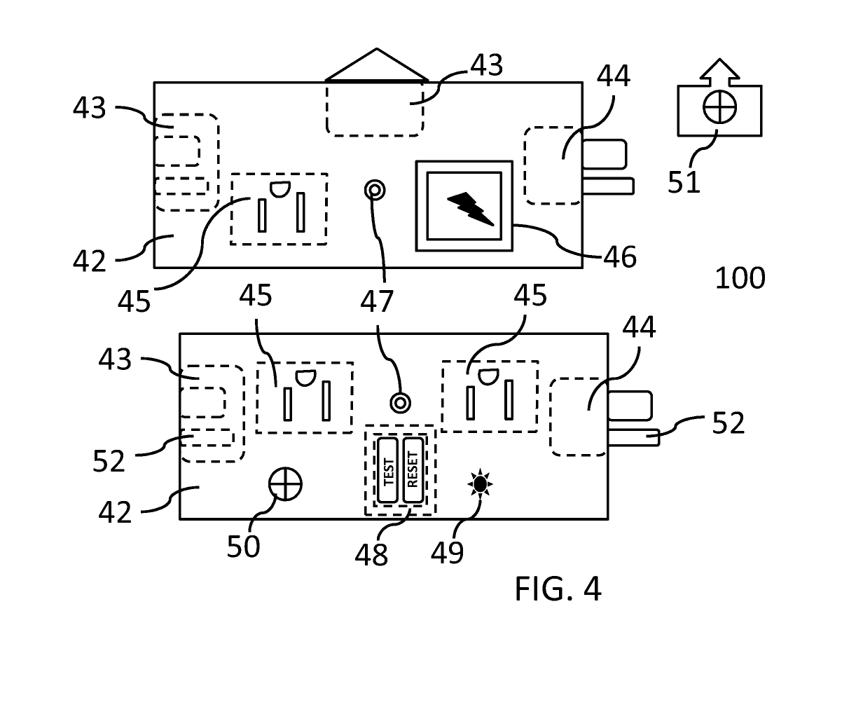

In the electric power distribution system of the present invention 100, the male connector 12 and female connector 13 may comprise a water resistant configuration. Further, the hollow rigid enclosures 10 of the present invention 100 may comprise a water resistant configuration when the hollow rigid enclosure 10 of a first power distribution device 11 is connected to the hollow rigid enclosure 10 of a second power distribution device 11 or other system components shown on FIG. 2, FIG. 3, and FIG. 4. The hollow rigid enclosure 10 may include electrical insulation and further comprise a decorative exterior appearance. The hollow rigid enclosure 10 may be fabricated using one of wood, metal, plastic, and composites.

Referring now to FIG. 2, the electric power distribution system of the present invention 100 may further comprise at least one adjustable length telescoping power distribution device 20. Each power distribution device 20 in the plurality of rigid power distribution devices 20 includes a hollow rigid enclosure 21 & 26 for containing at least electric power conductors 24 and connectors 22 & 23; electric power conductors 29 for transferring power received from an external power source; at least one male connector 22; and at least one female connector 23. At least one male connector 22 of a first power distribution device 20 is connectable to a female connector 23 of at least a second power distribution device 20 or third power distribution device (11, FIG. 1). A hollow rigid enclosure 21 & 22 of a first power distribution device 20 is connectable to the hollow rigid enclosure 21 & 22 of a second power distribution device 20 or third power distribution device (11, FIG. 1). The hollow rigid enclosure 21 & 26 of each device 20 is extensible 25 over a substantially flat surface and said electric power conductor 24 is correspondingly extensible 25 inside said hollow rigid structure 20. Further, the hollow rigid enclosures 21 & 26 of the present invention 100 may comprise a water resistant configuration when the hollow rigid enclosure 21 & 26 of a first power distribution device 20 is connected to the hollow rigid enclosure 21 & 26 of a second power distribution device 20 or other system components shown on FIG. 1, FIG. 3, and FIG. 4. The hollow rigid enclosures 21 & 26 may include electrical insulation and further comprise a decorative exterior appearance. The hollow rigid enclosures 21 & 26 may be fabricated using one of wood, metal, plastic, and composites.

Referring now to FIG. 3, the electric power distribution system of the present invention 100 may include a unique power distribution device 32 with at least one female receptacle 35 mounted on a surface of the hollow rigid enclosure 39 and one male connector 34 at one end and one female receptacle 33 at the opposite end of the hollow rigid enclosure 39 to allow interconnection with a plurality of power distribution devices shown on FIG. 1, FIG. 2, FIG. 3, and FIG. 4. The hollow rigid enclosure 39 of each device 32 is mountable on a substantially flat surface using a fastener positioned through a protected tubular pathway 37, or by mounting a bracket (16, FIG. 1) on said surface using a fastener penetrating a mounting hole (17, FIG. 1) in said bracket (16, FIG. 1). The plurality of hollow rigid enclosures 30, 31 & 32 may have differing dimensions and shapes, such as but not limited to inside and outside corner shapes 30 & 31. A weather proof cap 38 may be positioned on the end of said hollow rigid enclosure 39.

Referring now to FIG. 4, the electric power distribution system of the present invention 100 may comprise unique power distribution devices 42 of various configurations. The electric power distribution system of the present invention 100 may include at least one ground fault protector 48; at least one indicator light 49 that illuminates when power is present; at least one switch 50 that shuts off the power to at least one said power distribution device 42; at least one power monitoring device 46 that allows the user to monitor the current being transferred; and at least one receiver 43 for receiving wireless control from a remote device 51 that governs the supply of power. Connectors 43 & 44 are configured with a ground conductor 52, as are equivalent connectors shown in FIGS. 1, 2, & 3.

The hollow rigid enclosures included in the electric power distribution system of the present invention and shown in FIGS. 1 through 4 may further comprise a plurality of mounting penetrations for attachment to a surface using at least fasteners, or a plurality of mounting brackets to attach each power distribution device to a surface. Adhesive strips position on a back side of said hollow rigid enclosures may also be used for mounting.

The modular surface mountable electric power distribution system of the present invention is comprised of various multiple (e.g., 2 foot and 3 foot or other) length power distribution devices which contain appropriate sized electrical wire with a grounded male plug on one end and a grounded female plug on the other. In addition, the system includes a component which is a hollow device with a movable sleeve which contains a coiled electrical wire and male and female plugs matching the unmoving parts. This piece allows for exact adjustment of the total length of the pieces for each application. Power distribution devices may be configured in unique arrangements which include standard duplex format on the front and a male and female plug on the sides allowing the receptacle to be connected in any position to the above described lengths of power distribution devices. The system may also include convex and concave corner devices with male and female plugs to allow extension of the system around a room. The power distribution devices can be configured in any molded shape to conform to desired décor (square, quarter round, standard molding, etc.) and may be created in a flexible or corrugated design to accommodate curves. The first mounted power distribution device may be the component shown in FIG. 1 having an extensible connector that may be connected into an existing receptacle by a short flexible conductor. Alternatively, the initial connection could be hard-wired into the existing electrical system.

The system can be made in a weatherproof version with sealed plugs or integrated gaskets for deck or patio lighting and other electrical power supply/need. The system can be manufactured for additional wiring requirements such as for information transfer cables, speaker wires or other such electrical distribution needs. Data signal connectors and cables for distributed access to an external data port may be included.

The length may be adjustable to a plurality of room dimensions. It can be surface mounted on a wall, ceiling or floor by adhesive, peel strip tape, hook & loop or a specially designed clip mount bracket (included in drawings). It can mount at any height (for example, as a chair rail) and can be a paintable surface or custom color to match décor.

The system protects wires from minor damage from sharp edges and impact. Ends caps may be attached for safety. The receptacles conform to child safety devices and existing child-safety plugs can be used. This system eliminates safety hazard of tripping on cords. The system may be safely used for temporary lighting needs indoors or outdoors. Ease of installation by an unlicensed person is an objective in the structure of this system. It is adaptable and may be expanded without uninstalling previously installed components. Receptacles may be added at any connection in the rigid lengths of power distribution devices.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A modular surface mountable electric power distribution system, comprising:
a plurality of interconnectable power distribution devices, each power distribution device in said plurality of power distribution devices including
a hollow rigid enclosure for containing at least electric power conductors and connectors;
electric power conductors for transferring power received from an external power source;
at least one male connector;
at least one female connector;
where said at least one male connector of a first power distribution device is connectable to a female connector of a second power distribution device;
where said hollow rigid enclosure of a first power distribution device is connectable to said hollow rigid enclosure of a second power distribution device;
where said hollow rigid enclosure is mountable on a substantially flat surface, and
where said at least one male connector is connectable to said external power source.

2. The electric power distribution system of claim 1, where said male connector and said female connector comprise a water resistant configuration.

3. The electric power distribution system of claim 1, where said hollow rigid enclosure of said first power distribution device connected to said hollow rigid enclosure of said second power distribution device comprise a water resistant configuration.

4. The electric power distribution system of claim 1, further comprising a unique connector with at least one female receptacle mounted on a surface of said rigid hollow enclosure and one male plug and one female receptacle at each end of said rigid hollow enclosure to allow interconnection with a plurality of power distribution devices.

5. The electric power distribution system of claim 1, further comprising at least one adjustable length telescoping power distribution device.

6. The electric power distribution system of claim 1, further comprising a plurality of hollow rigid enclosures having differing dimensions and shapes.

7. The electric power distribution system of claim 1, where said hollow rigid enclosures further comprise electrical insulation.

8. The electric power distribution system of claim 1, further comprising at least one ground fault protector.

9. The electric power distribution system of claim 1, where said hollow rigid enclosure further comprises a decorative exterior appearance.

10. The electric power distribution system of claim 1, where said hollow rigid enclosure further comprises one of wood, metal, plastic, and composites.

11. The electric power distribution system of claim 1, further comprising at least one indicator light that illuminates when power is present.

12. The electric power distribution system of claim 1, further comprising at least one switch that shuts off the power to at least one said power distribution device.

13. The electric power distribution system of claim 1, further comprising at least one power monitoring device that allows the user to monitor the current being transferred.

14. The electric power distribution system of claim 1, where said hollow rigid enclosure further comprises mounting penetrations for attachment to a surface using at least fasteners.

15. The electric power distribution system of claim 1, further comprising at least one remote control that controls the supply of power.

16. The electric power distribution system of claim 1, further comprising clip mounting brackets to attach each said power distribution device to a surface.

17. A power distribution device connectable in a modular surface mountable electric power distribution system, comprising:
a hollow rigid enclosure for containing at least electric power conductors and connectors;
electric power conductors for transferring power received from an external power source;
at least one male connector;
at least one female connector;
where said at least one male connector of a first power distribution device is connectable to a female connector of a second power distribution device;
where said hollow rigid enclosure of a first power distribution device is connectable to said hollow rigid enclosure of a second power distribution device;
where said hollow rigid enclosure is mountable on a substantially flat surface, and
where said at least one male connector is connectable to said external power source.

18. The power distribution device of claim 17, further comprising a unique connector with at least one female receptacle mounted on a surface of said rigid hollow enclosure and one male plug and one female receptacle at each end of said rigid hollow enclosure to allow interconnection with a plurality of power distribution devices.

19. The power distribution device of claim 18, further comprising a hollow rigid enclosure having at least one of telescoping properties, a power indicator light, a ground fault protector, a power off switch, a power monitoring device, and data signal connectors and cables for distributed access to an external data port.

20. A method of configuring a modular surface mountable electric power distribution system, comprising:
providing a plurality of interconnectable power distribution devices, where each power distribution device in said plurality of power distribution devices includes a hollow rigid enclosure for containing at least electric power conductors and connectors; electric power conductors for transferring power received from an external power source; at least one male connector; and at least one female connector;
connecting said at least one male connector of a first power distribution device to a female connector of a second power distribution device;
connecting said hollow rigid enclosure of a first power distribution device to said hollow rigid enclosure of a second power distribution device;
mounting said hollow rigid enclosures on a substantially flat surface, and
connecting one male connector to said external power source.
